(19) United States
(12) Patent Application Publication
(10) Pub. No.: US 2011/0299155 A1
(43) Pub. Date: Dec. 8, 2011

(54) ENERGY REFLECTIVE DEVICE

(76) Inventor: Derrick J. McCarthy, Grand Rapids, MI (US)

(21) Appl. No.: 13/086,105

(22) Filed: Apr. 13, 2011

Related U.S. Application Data
(60) Provisional application No. 61/323,616, filed on Apr. 13, 2010.
(60) Provisional application No. 61/364,240, filed on Jul. 14, 2010.

(51) Int. Cl. G02B 5/26

(52) U.S. Cl. 359/359; 359/361

(57) ABSTRACT

An energy reflective device that includes a frame for receiving a substrate having an energy reflective coating, as disclosed herein.

### CROSS-REFERENCE TO RELATED APPLICATION(S)

This application claims the benefit of U.S. Provisional Application Ser. No. 61/323,616, filed Apr. 13, 2010, entitled “ENERGY REFLECTIVE DEVICE” and U.S. Provisional Application Ser. No. 61/364,240, filed Jul. 14, 2010, entitled “ENERGY REFLECTIVE DEVICE,” all of which are hereby incorporated herein by reference in their entirety, including all references cited therein.

### BACKGROUND OF THE INVENTION

1. Field of the Invention

The present invention relates in general to an energy reflective device and, more particularly, but not by way of limitation, to an energy reflective device that can reflect thermal energy such as Ultraviolet (UV) and Infrared (IR) light, wherein the energy reflective device includes at least one substrate that is reversibly installable proximate a window to prevent thermal energy loss through the same. Furthermore, the energy reflective device includes a low-emissive coating allowing the window to remain substantially transparent while reflecting substantially all UV light.

2. Background Art

In today's world, conservation of resources is of paramount concern. To be sure, reducing consumption of high cost utilities such as electrical power is greatly desired. Moreover, it is well known that upwards of 30% of a structure's heating and/or cooling requirements are directly related to thermal energy loss—the transmission of ultraviolet and/or infrared light via a structure's windows. Additionally, it has been estimated that upwards of 60% of electrical energy production goes to maintaining a controlled climate with structures.

Typical windows are substantially, if not completely, transparent and therefore have high thermal transmission rates. As such, many attempts have been made to reduce thermal energy loss through windows by coating them with a low-emissive film that can absorb and/or reflect thermal energy. These low-emissive films frequently include compounds such as copper or metal oxides that can be expensive. Unfortunately, in addition to blocking varying degrees of both ultraviolet and infrared light these films often undesirably block wanted visible light from entering the structure. Reduction of visible light transmitted through the window results in added use of artificial lighting which in turn increases electrical utility consumption. Additionally, typical low-emissive coatings and/or films are permanently overlaid onto windows and only prevent the transmission of thermal energy in a unidirectional manner.

It is therefore an object of the present invention to provide an energy reflective device, which, among other things, remedies the aforementioned detriments and/or complications associated with the use of the above-identified, conventional reflective devices.

These and other objects of the present invention will become apparent in light of the present specification, claims, and drawings.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 of the drawings is a perspective view of an energy reflective device covering at least a portion of a window;

FIG. 2 of the drawings is a cross-sectional view of the substrate of an energy reflective device;

FIG. 3 of the drawings is a cross-sectional view of a composite energy reflective device; and

FIG. 4 of the drawings is a cross-sectional view of a portion of a window in combination with an energy reflective device.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters.

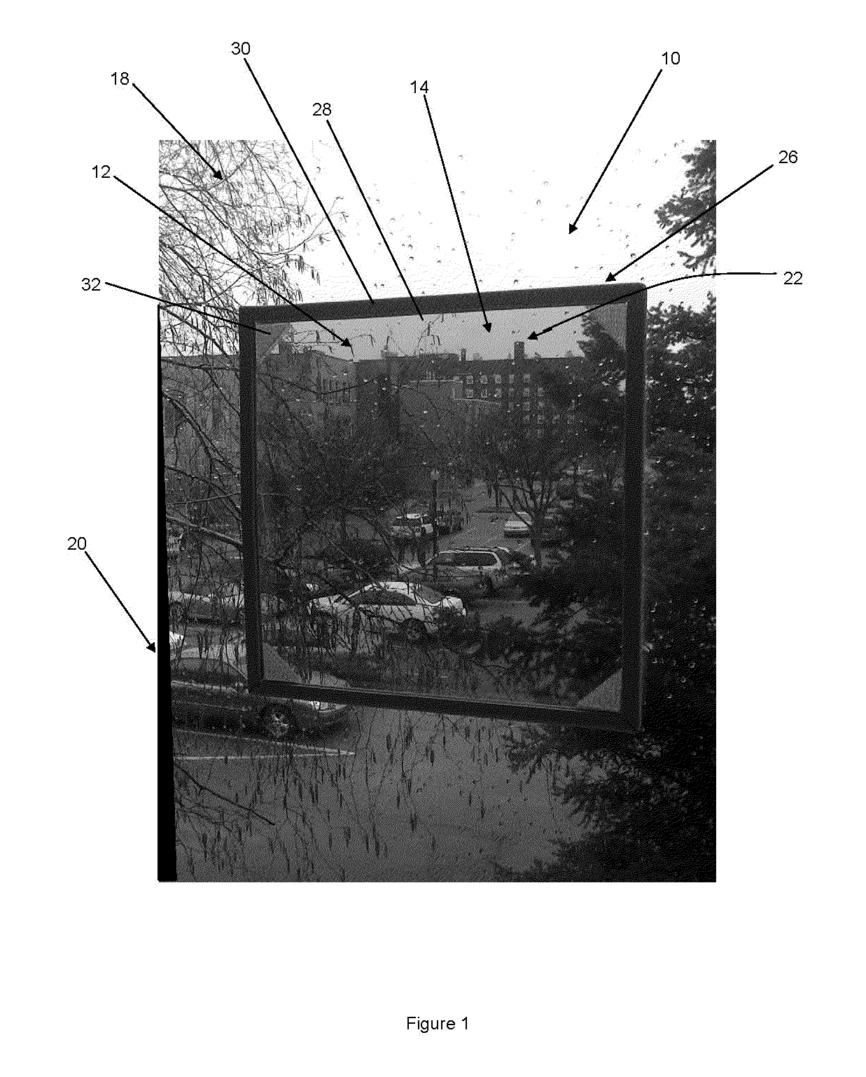

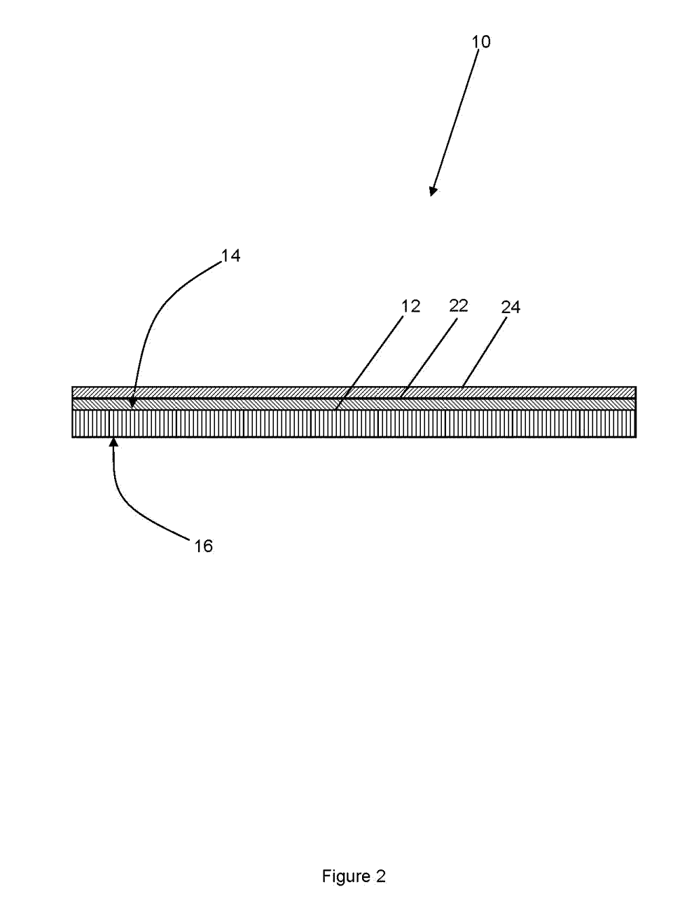

Referring now to the collective drawings (i.e., FIGS. 1-4), and more particularly to FIGS. 1-2, shown therein is an energy reflective device, hereinafter referred to as device 10. In one embodiment, device 10 includes substrate 12 having both first and second surfaces 14 and 16 (FIG. 2). In one embodiment, device 10 is provided to substantially cover window 18 that includes window frame 20.

Substrate 12 is preferably fabricated from a durable material such as a plastic, glass, polymer, resin, or the like. In one embodiment, substrate 12 is constructed from an impact resistant material such as polycarbonate, glass-phenolic, and acrylic—just to name a few. Furthermore, the coloring of substrate 12 may be at least one of substantially transparent, translucent, opaque, or the like. It will be understood that the particular use of substrate 12 may dictate the desired color thereof. For example, if substrate 12 is to be used in a residential setting where a high degree of natural light is desired, substrate 12 may be substantially transparent.

To reflect energy, at least one of first and second surfaces 14 and 16 may include a product disposed on the outer surface thereof. In one embodiment the product may preferably include one or more compounds that reflect at least one of UV and IR light, and in one particular embodiment, both. The product may be incorporated into a solvent or water borne coating 22 that may be applied to substrate 12 to at least partially cover at least one of first and second surfaces 14 and 16 thereof. Coating 22 may reflect any percentage of UV and IR light from greater than 0% to less than 100%, although in one embodiment the coating may reflect substantially 100% of the UV light contacting substrate 12 while allowing the same to remaining substantially transparent. Also, coating 22 may reflect approximately 90% of IR light. One particular non-limiting example of coating 22 is a commercially available product produced by 3S SOLAR BLOCK a division of Innovative Solutions, LLC, located in Lake Orion, Mich., sold under the trademark “3S SOLAR BLOCK.”

Coating 22 is preferably applied to at least one of first and second surfaces 14 and 16 of substrate 12 by way of one or more coating processes such as dip coating, spin coating, spraying, or the like. Furthermore, the energy reflective product may be incorporated into a film (not show) that is applied to substrate 12. As one of ordinary skill in the art will readily appreciate, these coating and filming processes are well known, therefore, for the sake of brevity, a detailed discussion of these processes will not be provided.

While it has been disclosed that at least one of first and second surfaces 14 and 16 comprise coating 22 or a film incorporating the energy reflective product, one of ordinary skill in the art will appreciate that the reflective product may be impregnated or otherwise incorporated into substrate 12.

In one embodiment, substrate 12 may include protective finish 24 (FIG. 2) that covers at least one of first and second surfaces 14 and 16 to protect the same from damage such as scratching, marring, and the like, and may also protect coating 22 or film from flaking, cracking, peeling, or other damage.

For ease of use and installation, device 10 may include frame 26 which covers outer peripheral edge 28 of substrate 12. In one embodiment, frame 26 may include a plurality of sections 30 that cooperate to form a rectangular shape that generally conforms to the size of window 18 or window frame 20. Frame 26 may be releaseably secured to at least one of inner and outer surfaces of window 18 and window frame 20 via connecting means 32 such as adhesive tabs, strips, brackets, interference fit, and the like.

The orientation of device 10 preferably depends upon the desired application and/or effect. More specifically, to prevent thermal energy from entering through window 18, device 10 is installed proximate the outer surface of window 18 with coating 22 of substrate 12 facing outwardly. Conversely, to prevent thermal energy from exiting from the structure via window 18, device 10 is installed proximate the inner surface of window 18 with coating of substrate 12 facing inwardly.

It will be understood that substrate 12 may absorb certain amounts of thermal energy. As such, the temperature of substrate 12 may increase during use. Moreover, as typical windows are constructed from glass they are highly susceptible to damage including cracking due to thermal expansion and/or contraction. Therefore, substrate 12 may be preferably spaced apart from window 18 to prevent transmission of thermal energy via direct contact between substrate 12 and window 18.

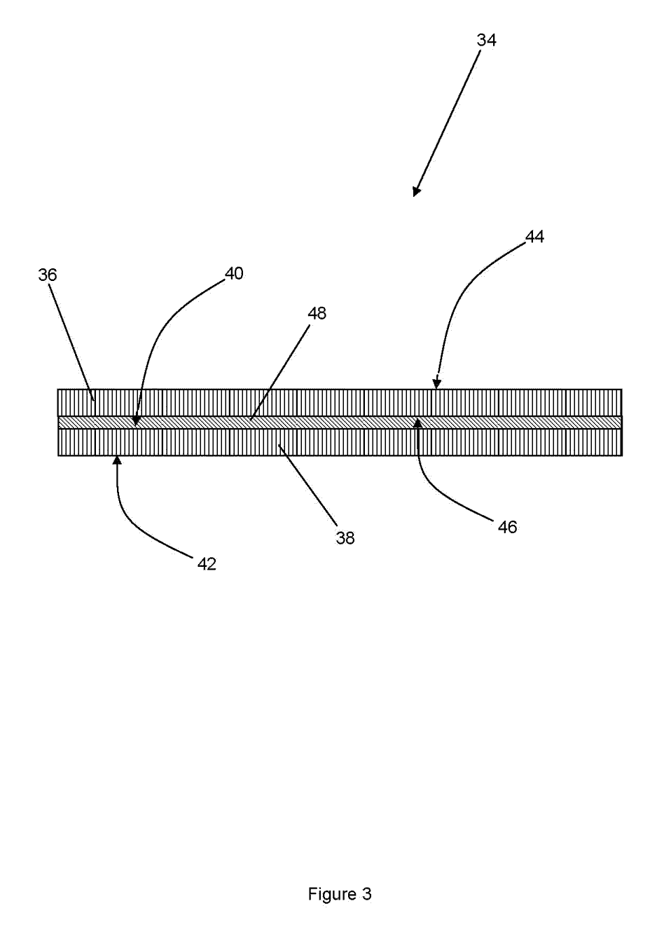

Referring now to FIG. 3, shown therein is composite device 34 that includes at least two or more layers of substrates. In one embodiment, device 34 includes two substrates 36 and 38. Substrates 36 and 38 may be fabricated from similar materials used to fabricate substrate 12, including durable materials such as a plastic, glass, polymeric material, resin, and the like. In one embodiment, substrates 36 and 38 are constructed from an impact resistant material such as polycarbonate, glass-phenolic, acrylic, and the like. Furthermore, the coloring of substrates 36 and 38 may be at least one of substantially transparent, translucent, opaque, or the like, similarly to substrate 12.

Each of substrates 36 and 38 include first and second surfaces 40 and 42, and 44 and 46, respectively.

To reflect thermal energy, one or more coatings 48 may be applied to substrates 36 and 38. Coatings 48 may be substantially identical in composition to the aforementioned coating 22 and may be applied to one or more of first and second surfaces 40 and 42, and 44 and 46 of substrates 36 and 38 via similar processes described with regards to coating 22.

In one embodiment, coating 48 may be disposed between substrates 36 and 38. Additionally, device 34 may include a frame (not shown) similar to frame 26 for releaseably securing device 34 to window (also not shown).

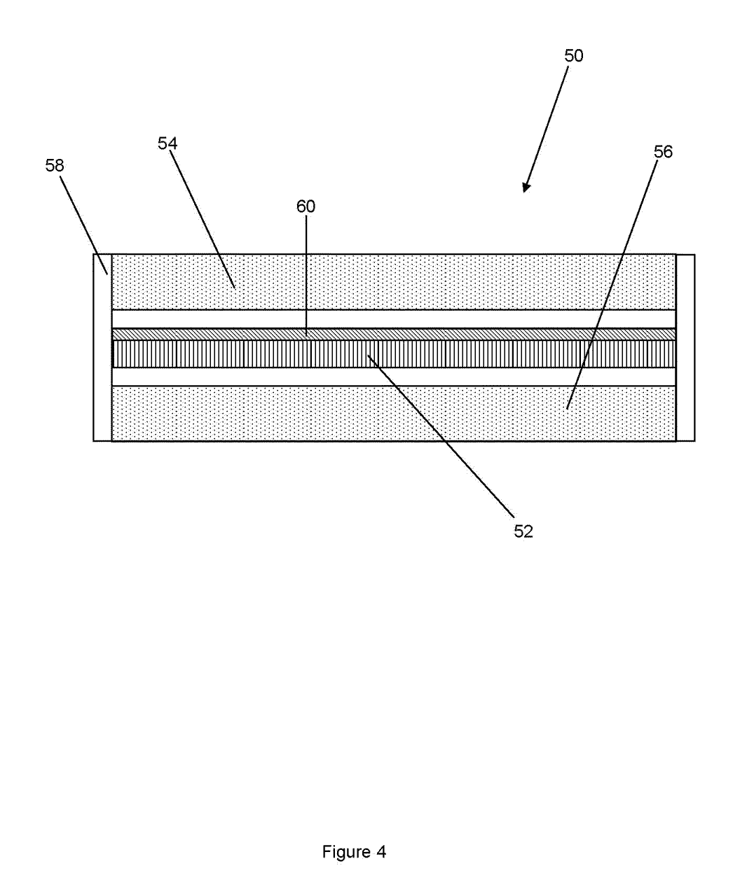

Referring now to FIG. 4, shown therein is window 50 in combination with substrate 52. In one embodiment, window 50 is a double pane window having first and second panes 54 and 56. Panes 54 and 56 are held in spaced apart relationship to one another by frame 58. Substrate 52 is constructed similarly to substrate 12 and includes coating 60.

In one embodiment, substrate 52 may be reversibly insertable between panes 54 and 56 such that coating 60 of substrate 52 may be disposed outwardly or inwardly depending on the application. In this embodiment, at least a portion of frame 58 may be selectively adjustable to allow substrate 52 to be reoriented as desired. For example, top edge (not shown) of frame 58 may be hingedly connected to an adjacent portion of frame 58 such that top edge may be opened and closed to provide access to the space between panes 54 and 56 where substrate 52 is received.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. An energy reflective device as provided in FIGS. 1-4 having one or more of the disclosed structural, functional, and/or ornamental characteristics.

2. An energy reflective device in combination with a single or double pane window having one or more of the disclosed structural, functional, and/or ornamental characteristics.

3. An energy reflective device, comprising: a frame for receiving a substrate having an energy reflective coating, as disclosed herein.
